(19) United States
(12) Patent Application Publication
(10) Pub. No.: US 2008/0320304 A1
(43) Pub. Date: Dec. 25, 2008

(54) Method of Accessing Data Content in Storage Devices

(75) Inventor: Wilhelmus Franciscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,473

(22) PCT Filed: Dec. 1, 2004
(86) PCT No.: PCT/IB04/52625

§ 371 Date: Jun. 14, 2006

(30) Foreign Application Priority Data
Dec. 19, 2003 (EP) 03104855.6

(51) Int. Cl. H04L 9/00; H04L 9/14; G06F 12/02

(52) U.S. Cl. 713/165; 707/205; 705/52; 380/282; 707/E17.01

(57) ABSTRACT

There is provided a data storage device (110, 280). The device (110, 280) is distinguished in that it includes a data storage medium (280, SFFO) arranged to bear data content thereon as a master file (MF) having an associated file name (AD0) for identifying an address range for locating and subsequently accessing and/or recording said master file (MF) on the medium (280, SFFO), the master file (MF) including substantially within its address range at least one sub-file (SF) having an associated file name for identifying an address range for locating and accessing and/or recording the sub-file (SF) on the medium (280, SFFO), the device (110, 280) being arranged such that at least one of reading data content from and writing data content to at least one of the master file (MF) and the at least one sub-file (SF) is facilitated by using their associated file names.

The present invention relates to methods of accessing data content in storage devices; in particular, but not exclusively, the present invention relates to a method of accessing data content in a storage device by way of multiple filenames relating to mutually overlapping data content, for example using master files including associated sub-files therein wherein both the master files and their associated sub-files are individually addressable by way of their corresponding file names. Moreover, the invention also relates to apparatus arranged to utilize the aforementioned method, for example when accessing and/or executing data content.

Data storage devices are known, for example magnetic and/or optical disc drives. Such storage devices conventionally are accessed by an associated operating system, namely more specifically a file system implementation, for relating an item of data content stored on the device, for example in one or more sectors of an optical memory disc, to a corresponding filename. Such a filename is occasionally referred to as a key identifier, for example an “asset-ID”. A filename conventionally relates to data content that can comprise a data field and/or a quantity of executable code.

Conventionally, a one-to-one correspondence between a filename and its corresponding data content pertains. However, in a U.S. Pat. No. 6,434,553, there is described a file pre-fetch control method including the steps of:

(a) dividing a file into a plurality of potential files furnished with a partial file name each; and
(b) converting a request to access any one of the partial files using the corresponding partial file name into a request to access the entire file to which the requested partial file belongs,

whereby the file as a whole is read out. The method described in that patent is of benefit in that when multiple files are pre-fetched in this manner, the throughput of the file system is enhanced, the number of access operations to a secondary memory utilized when implementing the method is reduced, and the wait time for access to partial files is shortened.

The inventor has appreciated that it is not only of benefit to provide for sub-file names relating to partial regions of a data content file as well as a filename relating to the entire data content file, but also of advantage to allow for the sub-file names to relate to overlapping data content. Moreover, the inventor has appreciated that various advantages arise from such overlapping association of sub-file names to data content because it is susceptible to preventing unauthorized data copying.

An object of the invention is to provide different rights definitions for different parts of effectively a same file.

It is a further object of the invention that it provides a data storage device susceptible to storing data content in an arrangement which renders the content less susceptible to hacking.

It is a further advantage of the invention that it provides a data storage device which is capable of providing greater data content security.

According to a first aspect of the present invention, there is provided a method of accessing and/or recording data content in a storage device, including the steps of:

(a) arranging for the data content on a data storage medium of the device to be a master file having an associated file name for identifying an address range for locating and subsequently accessing and/or recording said master file on the medium;
(b) arranging for the master file to include substantially within its address range at least one sub-file having an associated file name for identifying an address range for locating and accessing and/or recording the sub-file on the medium; and
(c) at least one of reading data content from and writing data content to at least one of the master file and the at least one sub-file using their associated file names.

The invention is capable of enhancing robustness of data content included in the master file from hacking or other types of incursion.

Preferably, in the method, there is a plurality of sub-files arranged to be mutually non-overlapping. Alternatively, preferably, there is a plurality of sub-files of which a sub-set thereof is arranged to be mutually overlapping.

Preferably, in the method, at least a sub-set of the at least one sub-file is in encrypted form. More preferably, in the method, the device is operable to access in sequence the sub-set of the at least one sub-file in encrypted form using corresponding decryption access keys. Yet more preferably, in the method, the decryption keys are provided to the device from data serving means via at least one authenticated communication channel. Beneficially, the at least one authenticated communication channel is established between the device and said one or more remote data servers using private-public key encryption.

Preferably, in the method, the storage device is operable to establish said at least one authenticated channel with said data serving means for obtaining one or more decryption keys.

Preferably, in the method, the device is arranged to destroy said at least one of the decryption keys received at the device after at least one of:

(a) a pre-determined time duration after receipt of the at least one key at the device; and
(b) substantially immediately after its corresponding sub-file has been decrypted within the device for executing thereof.

Preferably, in the method, the data storage medium is arranged to be detachable from the storage device. Such detachability allows for free-issue software to be used providing a free basic level of usability and an enhanced level of usability accessible by way of payment enabling selective use of encrypted data content supplied on the detachable storage medium. More preferably, in the method, the storage medium is a miniature optical data storage disc, more preferably a SFFO disc, also known as a Portable Blue (PB) disc.

Thus, in the method, the data content is preferably arranged to correspond to executable software code included within the master file, wherein the sub-files correspond to user-selectable options. More preferably, in the method, those sub-files included within the master file which are encrypted correspond to user-selectable software options accessible for execution to response to user-payment and/or other types of user consideration such as time to present advertisement to the user.

Preferably, in the method, the storage device is included as a part of a mobile telephone apparatus couplable to a communication network. More preferably, the data content stored in the master file of the storage device is at least one of pre-recorded onto the storage medium and downloaded from said communication network.

According to a second aspect of the present invention, there is provided a data storage device including a data storage medium arranged to bear data content thereon as a master file having an associated file name for identifying an address range for locating and subsequently accessing and/or recording said master file on the medium, the master file including substantially within its address range at least one sub-file having an associated file name for identifying an address range for locating and accessing and/or recording the sub-file on the medium, the device being arranged such that at least one of reading data content from and writing data content to at least one of the master file and the at least one sub-file is facilitated by using their associated file names.

Preferably, in the device, a plurality of sub-files are arranged to be mutually non-overlapping on the medium. Alternatively, or additionally, a plurality of sub-files are arranged so that a sub-set thereof is arranged to be mutually overlapping.

Preferably, in the device, at least a sub-set of the at least one sub-file is in encrypted form. More preferably, the device is arranged to be operable to access in sequence the sub-set of the at least one sub-file in encrypted form using corresponding decryption access keys. Most preferably, the decryption keys are arranged to be provided to the device from data serving means via at least one authenticated communication channel. Moreover, the at least one authenticated communication channel is established between the device and said one or more remote data servers using private-public key encryption.

Preferably, the device is operable to establish said at least one authenticated channel with said data serving means for obtaining one or more decryption keys.

For providing enhanced security and assisting to prevent hacking, the device is preferably arranged to destroy said at least one of the decryption keys received at the device after at least one of:

(a) a pre-determined time duration after receipt of the at least one key at the device; and
(b) substantially immediately after its corresponding sub-file has been decrypted within the device for executing thereof.

Preferably, the data storage medium is arranged to be detachable from the device. More preferably, the storage medium is a miniature optical data storage disc, more preferably a SFFO disc, for example as developed and/or produced by Philips N.V.

Preferably, in the device, the data content is arranged to correspond to executable software code included within the master file, wherein the sub-files correspond to user-selectable options. More preferably, those sub-files included within the master file which are encrypted correspond to user-selectable software options accessible for execution to response to user-payment and/or other form of user-consideration, for example exposing the user to advertisement material.

Preferably, the storage device is included as a part of a mobile telephone apparatus couplable to a communication network. More preferably, the data content stored in the master file of the device is at least one of pre-recorded onto the storage medium and downloaded from said communication network. Most preferably, the storage medium is susceptible to free distribution with user-payable options included in sub-files in encrypted form.

It will be appreciated that features of the invention are susceptible to being combined in any combination without departing from the scope of the invention.

Embodiments of the invention will now be described, by way of example only, with reference to the diagrams, wherein:

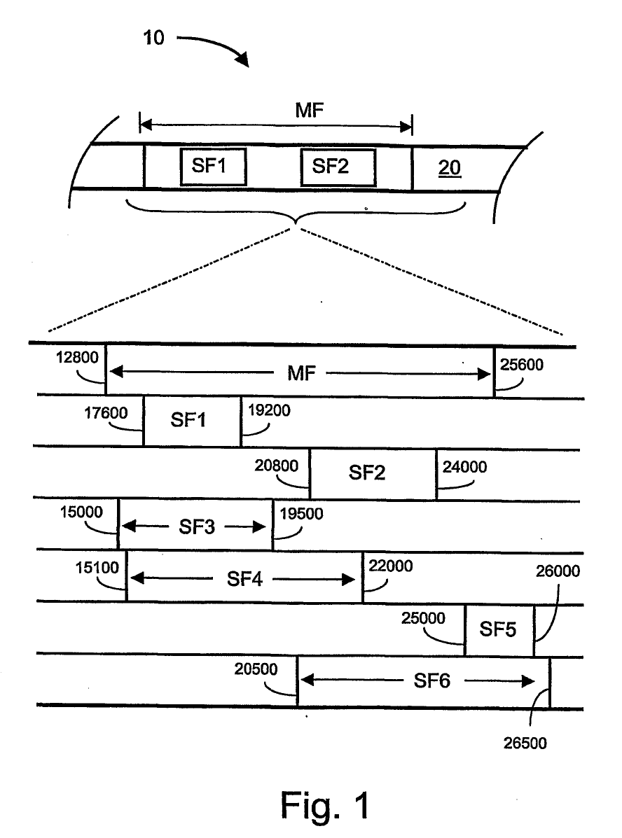

FIG. 1 is an illustration of a part of a data carrier having recorded thereon a master file (MF) together with associated sub-files (SF1 to SF6), some of the sub-files overlapping the master file (MF) and some of the sub-files also being arranged to mutually overlap;

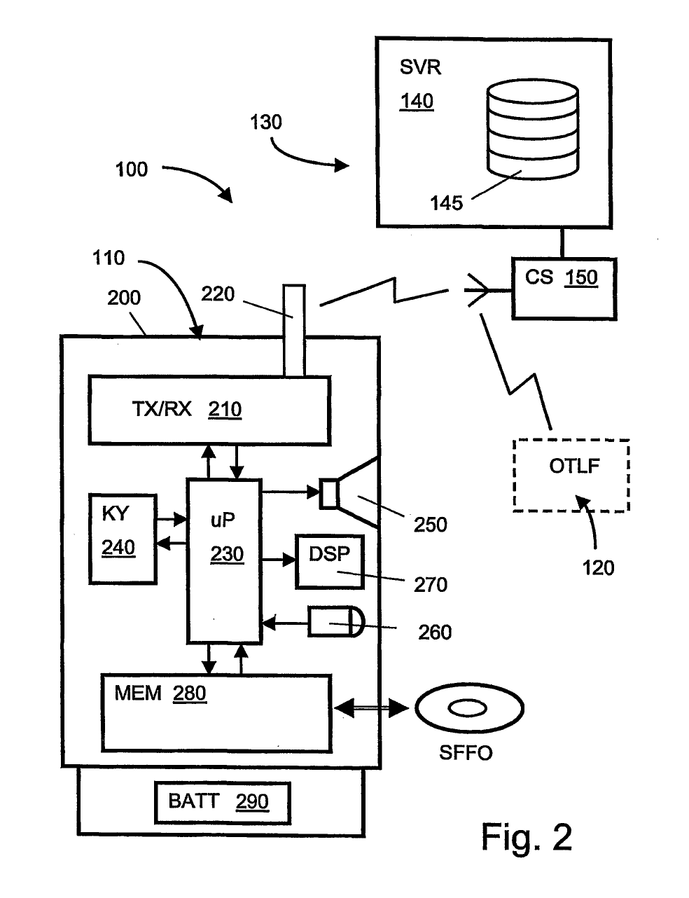

FIG. 2 is an illustration of a communication network comprising a plurality of mobile telephones and communication infrastructure, at least one of the telephones employing therein a recording arrangement for data as depicted in FIG. 1; and

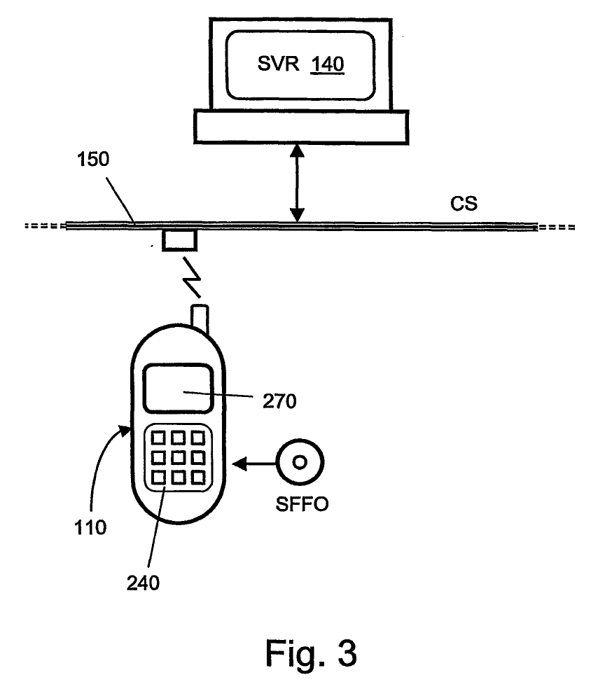

FIG. 3 is another illustration of the network in FIG. 2 in simplified presentation.

In overview, the inventor has envisaged that, in a contemporary storage device such as an optical disc drive including a readable/writable optical-disc data-carrying medium comprising a plurality of data sectors, a data file corresponds to a collection of at least one of the sectors addressable by way of a single identifier known as a filename. Thus, the filename corresponds to a data asset in the said at least one of the sectors. Such assets can be at least one of data and executable software code. In the case of executable code, invoking the filename can, in certain device arrangements, also cause execution of the corresponding code. The inventor has appreciated that it is desirable to employ different keys for different parts of the file in a manner not supported in contemporary Digital Rights Management (DRM). Moreover, the inventor proposes to use, for example within contemporary Universal Disk Format (UDF), overlapping allocation descriptors (AD) to define multiple access keys for one or more files.

In order to further elucidate an embodiment of the present invention, reference will now be made to FIG. 1. In FIG. 1, a part of a data medium is indicated generally by 10. The medium 10 includes a data region 20. The data region 20 has recorded thereon, for example magnetically and/or optically, a master file (MF) having sub-files SF1 and SF2. The sub-files SF1 and SF2 occupy mutually different regions of the master file MF and are therefore mutually non-overlapping. However, both of the sub-files SF1 and SF2 overlap the master file MF as illustrated. Moreover, the master file MF optionally also includes a sub-file SF3 lying within the master file MF and encompassing the sub-file SF1; for example, the sub-file SF3 may be an executable piece of software using subroutines present in the sub-file SF2.

Other sub-file arrangements are also possible, for example the master file MF optionally also includes a sub-file SF4 lying within the master file MF and encompassing the sub-file SF1 and a portion of the sub-file SF2; for example, the sub-file SF4 is executable software using all subroutines of the sub-file SF1 and a sub-set of subroutines included in the sub-file SF2. Other master-file/sub-file configurations exist, for example a sub-file SF5 comprises a portion of the master file MF and a data field extending beyond the master file MF; such an arrangement is potentially of advantage to confuse hackers who expect the master file MF to be the extent of the executable software in question. Moreover, another example is where a sub-file SF6 shown encompasses the sub-field SF2, a portion of the master field MF and a data field extending beyond the master file MF.

The master file MF has an associate allocation descriptor AD0 defining a start address (SA) and a file length (FL) within the data region 20, namely the descriptor AD0 is expressible as:

AD0 [SA, FL]

The master file MF and the sub-files SF1 to SF6, for example, have associated allocation descriptors as provided in Table 1.

TABLE 1

| File | Start address (SA) | End address | File length (FL) |
|---|---|---|---|
| MF (AD0) | 12800 | 25600 | 12800 |
| SF1 (AD1) | 17600 | 19200 | 1600 |
| SF2 (AD2) | 20800 | 24000 | 3200 |
| SF3 (AD3) | 15000 | 19500 | 4500 |
| SF4 (AD4) | 15100 | 22000 | 6900 |
| SF5 (AD5) | 25000 | 26000 | 1000 |
| SF6 (AD6) | 20500 | 26500 | 6000 |

It will be appreciated that Table 1 is an illustrative example of various ways in which the master file MF and its associated sub-files SF1 to SF6 can overlap. Other configurations of overlap of the master file MF and its sub-files are possible.

The inventor has appreciated that overlapping allocation descriptors would not be regarded in the state of the art as desirable because such overlapping of sub-files is broken or disturbed when files are moved within a data carrying medium, for example within the medium 10. However, such disturbance is susceptible to being used to benefit because it is capable of preventing unauthorized copying of data content as relocation potentially renders such data content unusable unless an authenticated application capable of correctly relocating the data content and updating the file references is utilized.

Thus, an arrangement of the master file MF and its associated sub-files SF1 to SF6 offers a possibility of having multiple access keys, especially when one or more of the sub-files SF1 to SF6 are encrypted but yet accessible by using associated encryption access keys. Such access will be described in more detail later.

The use of master files including sub-files wherein each sub-file has an associated allocation descriptor invocable using a corresponding filename is especially appropriate for highly compact electronic data memories for portable electronic apparatus such as mobile telephones. For example, Philips N.V. in the Netherlands, as reported at an exhibition “Ceatec 2002” held in Japan, has recently developed a memory optical disc drive susceptible to replacing solid-state memory cards. The disc drive is known in the art as a small form factor optical storage, namely “SFFO” or Portable Blue (PB). In Philips N.V.'s prototype drive, one or more data-storage optical discs are employed, each disc having a diameter in the order of substantially 30 mm and being capable of storing 1 Gbyte of data content.

Philips N.V.'s Portable Blue (PB), also known as SFFO, is based on blue laser technology and is anticipated to replace DVD-ROM products in the next few years. Blue lasers have a shorter wavelength than red lasers conventionally employed to read contemporary DVD-ROMs and CD-ROMs, thus the use of blue lasers enables less space to be utilized to store a given quantity of data. Presently, Philips N.V.'s blue-laser memory disc drives are capable of squeezing 1 Gbyte of data content, namely approximately 50% more data than in a conventional CD-ROM, onto a miniature disc whose diameter is comparable to that of a contemporary Euro coin.

The principle of the master file MF and its associated sub-files SF1 to SF6 as described in the foregoing is of potential benefit in rendering data content in the form of executable software code which is more tamper resistant. Hitherto, the inventor has appreciated that there has been an absence of definite solutions to the problem of making software tamper resistant. Present solutions to protect against tampering of executable software do not allow for “fine grain” control of executable software functionality. Most contemporary approaches rely on a sophisticated digital rights management (DRM) approach which focuses on content encryption of a data-content master file as a whole. In general, the inventor has found that contemporary copy control and systems employing the aforementioned DRM exhibit dramatically reduced flexibility in order to enhance data content security, for example against tampering, such inflexibility constituting a technical problem which the present invention seeks to address.

The inventor has proposed that data content, for example executable software, is susceptible to being protected at a content-recipient side, in contradistinction to a corresponding content-supplying side, by incremental decryption using one or more access keys supplied over one or more secure live communication connections. Beneficially, the one or more access keys are provided from a data server. Advantageously, the recipient side is a user having a mobile telephone provided with the aforementioned SFFO data storage drive. Such software provided from the content-supplying side is preferably stored at the content-recipient side in the aforementioned master file MF having associated therewith a plurality of sub-files each having its specific associated encryption access key and filename.

In operation, data content in the form of executable software is either supplied with the aforesaid mobile telephone pre-stored in its SFFO drive or downloaded from a data content data source, for example a data server, into the SFFO drive. In a situation where the data content is dormant in the SFFO drive, the data content is capable of being activated by receipt of appropriate access encryption keys to de-encrypt the content in incremental steps relating to its encrypted individual sub-files as described in the foregoing. In a situation where data content is downloaded from a server, the data content is arranged so that it forms at least one master file having a file name with associated sub-files each having corresponding file names and at least a sub-set of the sub-files each being encrypted; subsequently, decryption keys are susceptible to being downloaded from either the same server as the data content and/or another server so as to render the downloaded software operable on the telephone. The decryption keys are susceptible to being time-limited in effect and/or released in response to payment of a license fee; for example, the downloaded data content can be software which is executable to provide motion image presentation on a screen of a mobile telephone in response to payment causing downloading of a subscription key for activating the downloaded software. Preferably, the subscription key corresponds to a sequence of graded keys relating to sub-fields of the downloaded software which are addressable as a whole by a master filename and whose sub-files are addressable by way of sub-file filenames. Relocation and/or copying of the downloaded software from the mobile telephone resulting in redistribution of the software, for example fragmentation when copied over to other storage devices, is then susceptible to causing the software not to function, thereby acting as a deterrent to software hacking.

In order to further elucidate the present invention, an embodiment of the invention will now be described in more detail with reference to FIG. 2.

In FIG. 2, there is shown a communication network indicated generally by 100. The network 100 comprises a mobile telephone device 110 together with optionally one or more similar telephone devices (OTLF) indicated by 120. The network 100 further comprises a network infrastructure indicated generally by 130 comprising distributed transmission infrastructure (CS) 150; for example, the transmission infrastructure 150 comprises radio masts, optical fibre communication links and signal switching apparatus such as DWDM routers. The infrastructure 130 includes at least one server, for example a server (SVR) 140 having an associated data storage device 145; the storage device 145 is arranged to store a variety of types of data, for example decryption keys, access keys, user accounts and registration details as well as executable application software. information.

The telephone device 110 includes an exterior enclosure 200 for protection, for example a plastic shell manufactured from injection-moulded plastics material. Moreover, the device 110 further comprises a radio transceiver module 210 coupled to a patch antenna and/or stub antenna 220 operable to provide radio communication with the distributed transmission infrastructure (CS) 150. The device 110 also includes a microprocessor (uP) 230 coupled to a user-operable key pad (KY) 240, for example for entering standard messaging system (SMS) text, telephone numbers and similar types of data as well as selecting user options as described later. The microprocessor 230 is further connected to a miniature loud-speaker 250, a miniature microphone 260, a miniature liquid crystal display (DSP) 270 and a storage device (MEM) 280 implemented by way of the aforementioned SFFO optical drive. Moreover, the device 110 includes an internal source of power (BATT) 290, for example in the form of a lithium and/or metal halide rechargeable battery.

In operation, the storage device 280 has executable operating system software loaded there onto for enabling the device 110 to communicate with the transmission infrastructure 150 and, when required, with the server 140. A user of the device 110 is thereby capable of communicating with one or more of the similar telephone devices 120 and/or accessing data or writing data to the server 140, for example electronic instructions to pay invoices and entering telephone user details.

A software application developer has created a navigation system for use with the device 110. The system is implemented, at least in part, as executable application software which the microprocessor 230 of the device 110 is capable of executing and which is capable of being stored in the storage device 280. The software application comprises a relatively large database of maps and an executable part which is partially encrypted, namely the executable part is implemented as a master file including a plurality of sub-files of which a subset is encrypted, preferably by way of a plurality of mutually different access decryption keys.

The application software providing the navigation system is published as a SFFO disc which is given away free to users, the disc being user insertable into the storage device (MEM) 280 of the telephone device 110. The user of the device 110 is able to insert the free SFFO disc into the storage device 280 and thereafter browse for free the aforementioned relatively large database of maps. However, in order to search the database for a specific address or to plan a route, the user of the device 110 has to pay for such privilege. The payment can be in the form of a cash transaction via a connecting server coupled to the infrastructure 150 and/or a forced delay of a searching result from the aforementioned database of maps whilst the user of the device 110 is presented with an advertisement on the display 270. The advertisement can, for example, be based on a location which the user of the device 110 wishes to visit and/or access, for example a nearest pizza parlour or hamburger restaurant.

When the user has installed the free SFFO disc into the device 110, for example as illustrated in FIG. 3, and commences execution of the software application, all options potentially provided by the application are presented on the display 270 to the user and/or acoustically via the loudspeaker 250 to the user, for example options of invoking one or more of browsing and route planning. If the user selects using the key pad 240 to browse the maps on the SFFO disc, activity associated therewith is local to the device 110 and does not invoke communication with the infrastructure 150 and its associated server 140. Only that part of executable software included on the SFFO disc which is unencrypted will be used in such a local free browsing mode of operation. As soon as the user selects an option of the software application presented on the display 270 which is not free, namely corresponds to executable software sub-files on the free SFFO disc in encrypted form, the user is presented initially with a warning on the display 270 that the use of the selected option will invoke a portion of the application software which is not free. Preferably, in such a situation, the user of the device 110 is presented on the display 270 with a price list for different encrypted options on the SFFO disc and/or different payment models. The user is then able to abort an action just performed to invoke non-free options, or choose a task presented and/or one or more of the payment models. Alternatively, the user can choose, for example using the key pad 240, not to be confronted with such a warning at all, or not any more, by selecting corresponding options in a configuration menu presented on the display 270. In a situation where the user of the device 110 has taken a subscription with the provider of the free SFFO disc, the device 110 can be arranged not to present such a warning to the user, for example by the device 110 interrogating the server 140 via the infrastructure 150.

Thus, if the user selects a task or option of the display 270 which is not free, the software application executing in the microprocessor 230 will contact the server 140 by way of the transceiver 210 and its antenna 220 in conjunction with the infrastructure 150. When contacted, the server 140 is operable to relate a telephone number of the device 110 with an active corresponding subscription registered on the server 140; if an association is found, namely the user has paid such a subscription, the server 140 checks that the option selected by the user is compatible with allowed options addressed by the subscription. When the server 140 identifies that the user is entitled to use the option selected at the key pad 240, an access key required by the microprocessor 230 to decrypt an encrypted sub-file of the software application on the free SFFO disc is communicated via a secure authenticated communication channel which the software application executing on the microprocessor 230 of the device 110 is capable of establishing from the device 110 to the server 140. Establishment of the authenticated communication channel optionally utilizes security measures such as private-public key encoding procedures as known in the art.

When the user selects a non-free option when executing the software application on the device 110, the decryption key sent from the server 140 via the established authenticated channel to the device 110 is preferably time limited so that software sub-files loaded into the device 110 from the free SFFO disc are decrypted for immediate executing and then any trace of the key in the device 110 is erased or destroyed to reduce a risk of hacking occurring. In view of the transient occurrence of the key in the device 110, it is more difficult for a hacker to gain access to the key in comparison to a key stored permanently on the device 110, for example in solid-state non-volatile memory associated with the microprocessor 230.

Paid for functionality in the device 110 associated with encrypted sub-files which are selectively decrypted using down-loaded decryption keys from the server 140 in return for payment may be rendered available in the device 110 until the application software exits its execution, for example the user switches off the device 110. Alternatively, the paid for functionality may be time limited such that the decryption key effectively expires in the device 110. Yet alternatively, the paid for functionality may be arranged to expire after a predetermined number of route searching results having been presented on the display 270 to the user.

As elucidated in the foregoing, the software application providing navigation functionality in the device 10 includes executable code subdivided in sub-sections in the form of sub-files SF as described earlier with reference to FIG. 1; namely, on the free SFFO disc, the sub-files can be included in the master file MF and can be either adjacent or overlapping as appropriate, for example in a manner as illustrated in FIG. 1. Moreover, to make it extremely difficult for hackers, certain sub-files on the SFFO disc can lie partially within a master MF region of the disc and partly beyond. Thus, by subdividing the application software code on the SFFO disc into sub-files, each sub-file being provided with its corresponding sub-file name, and using mutually different encryption keys for protecting the sub-files against hackers, and also arranging for executable software code associated with the sub-files to be configured to execute in sequence, it is possible to ensure that single execution of the software application is assured.

For example, executable software code in the sub-file SF1 that enables the user to select a geographical route to be calculated may be decrypted firstly in the device 110, after which its associated first decryption key securely communicated via an authenticated channel from the server 140 to the device 110 is destroyed. After the calculation of the geographical route is completed using software in the sub-file SF1 on the free SFFO disc, a different second decryption key is sent from the server 140 via the authenticated communication channel to the device 110 for use in decrypting executable software in the sub-file SF2 recorded on the free SFFO disc, the software of the sub-file SF2 being usable in the device 110 for receiving the calculated results of the route and formatting them in a form suitable for presentation on the display 270; after displaying the results, the second decryption key is destroyed in the device 110.

Preferably, the disc drive 280 of the device 110 is configured to be able to recognize whether a SFFO disc inserted into the drive 280 is a read-only (RO) SFFO disc or a writable SFFO disc (R/RW). By such configuration of the device 110, it is possible to reduce a risk of a hacker being able to gain unauthorized access to data content on the free SFFO disc.

It will be appreciated that embodiments of the invention described in the foregoing are susceptible to being modified without departing from the scope of the invention.

When describing embodiments of the invention in the foregoing, and also with regard to the accompanying claims, expressions such as “comprise”, “include”, “incorporate”, “contain”, “is”, “have” are intended to be construed non-exclusively, namely allowing for other items and/or components not explicitly named to be also present.

1. A method of accessing and/or recording data content in a storage device (280), including the steps of:
(a) arranging for the data content on a data storage medium (10) of the device to be a master file (MF) having an associated file name for identifying an address range for locating and subsequently accessing and/or recording said master file on the medium;
(b) arranging for the master file to include substantially within its address range at least one sub-file (SF1) having an associated file name for identifying an address range for locating and accessing and/or recording the sub-file on the medium; and
(c) at least one of reading data content from and writing data content to at least one of the master file and the at least one sub-file using their associated file names.

2. A method according to claim 1, wherein there is a plurality of sub-files (SF1-2) arranged to be mutually non-overlapping.

3. A method according to claim 1, wherein there is a plurality of sub-files (SF1-6) of which a sub-set thereof is arranged to be mutually overlapping.

4. A method according to claim 1, wherein at least a sub-set of the at least one sub-file is in encrypted form.

5. A method according to claim 4, wherein the device is operable to access in sequence the sub-set of the at least one sub-file in encrypted form using corresponding decryption access keys.

6. A method according to claim 5, wherein the decryption keys are provided to the device from data serving means via at least one authenticated communication channel.

7. A method according to claim 6, wherein the at least one authenticated communication channel is established between the device and said one or more remote data servers (140) using private-public key encryption.

8. A method according to claim 6, wherein the storage device is operable to establish said at least one authenticated channel with said data serving means for obtaining one or more decryption keys.

9. A method according to claim 5, wherein the device is arranged to destroy said at least one of the decryption keys received at the device after at least one of:
(a) a pre-determined time duration after receipt of the at least one key at the device; and
(b) substantially immediately after its corresponding sub-file has been decrypted within the device for executing thereof.

10. A method according to claim 1, wherein the data storage medium is arranged to be detachable from the storage device.

11. A method according to claim 10, wherein the storage medium is a miniature optical data storage disc, more preferably a SFFO disc.

12. A method according to claim 1, wherein the data content is arranged to correspond to executable software code included within the master file, wherein the sub-files correspond to user-selectable options.

13. A method according to claim 12, wherein those sub-files included within the master file which are encrypted correspond to user-selectable software options accessible for execution to response to user-payment.

14. A method according to claim 1, wherein the storage device is included as a part of a mobile telephone apparatus (110) couplable to a communication network.

15. A method according to claim 14, wherein the data content stored in the master file of the storage device is at least one of pre-recorded onto the storage medium and downloaded from said communication network.

16. A data storage device, including a data storage medium (10) arranged to bear data content thereon as a master file (MF) having an associated file name for identifying an address range for locating and subsequently accessing and/or recording said master file on the medium, the master file including substantially within its address range at least one sub-file having an associated file name for identifying an address range for locating and accessing and/or recording the sub-file (SF1-SF6) on the medium, the device being arranged such that at least one of reading data content from and writing data content to at least one of the master file and the at least one sub-file is facilitated by using their associated file names.
